(19) United States
(12) Patent Application Publication
(10) Pub. No.: US 2026/0078800 A1
(43) Pub. Date: Mar. 19, 2026

(54) THIN SECTION BALL BEARING

(71) Applicant: AKTIEBOLAGET SKF, GOTEBORG (SE)

(72) Inventors: William D. SCHMIDT, Muskegon, MI (US); Jonathan CLAYTON, Canton, MI (US)

(21) Appl. No.: 18/884,383

(22) Filed: Sep. 13, 2024

(51) Int. Cl. F16C 19/08; F16C 33/40; F16C 33/58; F16C 33/64

(52) U.S. Cl. CPC F16C 19/08; F16C 33/40; F16C 33/585; F16C 33/64

(57) ABSTRACT

A thin-section bearing includes an inner ring connectable with an inner member and having first and second inner raceways spaced axially apart. Each inner raceway has a pair of curved surface sections each having a radius of curvature with a separate center, the two centers being spaced axially apart. A multi-piece outer ring is disposed coaxially about the inner ring, is connectable with an outer member and has first and second outer raceways spaced axially apart. Each outer raceway has a pair of curved surface sections each having a radius of curvature with a separate center, the two centers being spaced axially apart. A first ball set is disposed between the first inner and outer inner raceways and a second ball set is disposed between the second inner and outer raceways. The balls of the first ball set have a greater diameter than the balls of the second set.

### BACKGROUND OF THE INVENTION

The present invention relates to bearings, and more particularly to thin-section ball bearings for connecting axially-spaced components.

Thin-section bearings are known and are referred to as such due to the relatively large diameters of the inner and outer rings in comparison with the axial thickness of the rings, and typically have a relatively constant ring thickness and axial width over a variety of different diameters. Such bearings are often used in the joints of robotic machinery in which the bearing connects two axially spaced components, for example, an arm and a shoulder of a robotic joint.

In these applications, there is often the need to support relatively high loading, such that it is important for the bearing to have a high stiffness. However, increased stiffness tends to also increase friction within the bearing, with a subsequent increase in the torque required to rotate or angularly displace the components rotatably coupled by the bearing. As such, the responsiveness and efficiency of the joint or other assembly incorporating the bearing is decreased.

### SUMMARY OF THE INVENTION

In one aspect, the present invention is a thin-section bearing for rotatably coupling a rotatable inner member with a fixed outer member. The bearing comprises an inner ring connectable with the inner member and having a central axis, a first inner raceway and a second inner raceway spaced axially from the first inner raceway. Each one of the first and second inner raceways has a pair of curved surface sections each having a radius of curvature with a center, the centers of the two radii of curvature of each pair of curved surface sections being spaced axially apart. An outer ring is disposed coaxially about the inner ring, connectable with the outer member and has a first outer raceway disposed about the first inner raceway and a second outer raceway spaced axially from the first inner raceway and disposed about the second inner raceway. Each one of the first and second outer raceways has a pair of curved surface sections each having a radius of curvature with a center, the centers of the two radii of curvature of each pair of curved surface sections of the first and second outer raceways being spaced axially apart.

Further, a first ball set includes a plurality of first balls disposed between the first inner raceway and the first outer raceway, each first ball having a first diameter and contacting each one of the curved surface sections of both of the first inner and outer raceways. Preferably the number of balls of the first ball set is selected such that at least 65.2% of a pitch circle defined between the first inner and outer raceways is occupied by the first ball set. A second ball set includes a plurality of second balls disposed between the second inner raceway and the second outer raceway, each second ball having a second diameter and contacting each one of the curved surface sections of both of the second inner and outer raceways. The second diameter is less than the first diameter, i.e., the balls of the second set are smaller than the balls of the first set. Preferably, the number of balls of the second ball set is selected such that at least 65.5% of a pitch circle defined between the second inner and outer raceways is occupied by the second ball set. With this structure of the raceways and balls, the bearing of the present invention is an eight-point contact bearing with a relatively high stiffness and relatively low friction.

Furthermore, the inner ring preferably has a first circumferential groove extending radially inwardly from the first inner raceway between the pair of curved surface sections of the first inner raceway and a second circumferential groove extending radially inwardly from the second inner raceway and between the pair of curved surface sections of the second inner raceway. Similarly, the outer ring preferably has a first circumferential groove extending radially outwardly from the first outer raceway between the pair of curved surface sections of the first outer raceway and a second circumferential groove extending radially outwardly from the second outer raceway between the pair of curved surface sections of the first inner raceway. With these two sets of grooves, the bearing preferably further comprises a first annular separator and a second annular separator. The first annular separator having two opposing axial ends, a plurality of pockets spaced circumferentially apart and each extending between the axial ends, an inner radial end disposed within the first circumferential groove of the inner ring and an outer radial end disposed within the first circumferential groove of the outer ring. Each ball of the first set of balls is disposed within a separate one of the pockets of the first separator. The second separator has a plurality of pockets, an inner radial end disposed within the second circumferential groove of the inner ring and an outer radial end disposed within the second circumferential groove of the outer ring, each ball of the second set of balls being disposed within a separate one of the pockets of the second separator.

Also, the outer ring preferably includes three ring portions, as follows. A central ring portion has first and second axial ends and inner and outer radial ends, one of the first outer raceway curved surface sections extending between the first axial end and the inner radial end and one of the second outer raceway curved surface sections extends between the second axial end and the inner radial end. A first end ring portion has an inner axial end disposed against the first axial end of the central ring portion, an outer axial end, an inner radial end and an outer radial end, the other one of the two curved surface sections of the first outer raceway extends between the inner axial end and the inner radial end of the first end ring portion. A second end ring portion has an inner axial end disposed against the second axial end of the central ring portion, an outer axial end, an inner radial end and an outer radial end, the other one of the two curved surface sections of the second outer raceway extending between the inner axial end and the inner radial end of the second end ring portion. The three ring portions are preferably connected together by a plurality of fasteners each extending through all three rings.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a side plan view of the bearing in accordance with the present invention;

FIG. 2 is an axial cross-sectional view through line 2-2 of FIG. 1;

FIG. 3 is a broken-away, enlarged axial cross-sectional view of an upper portion of the bearing, shown connected with an inner member and an outer member;

FIG. 4 is a broken-away, more enlarged axial cross-sectional view of the bearing, showing the details of bearing raceways;

FIG. 5 is a broken-away, enlarged axial cross-sectional view of an upper portion of an inner ring of the bearing;

FIG. 6 is a broken-away, enlarged axial cross-sectional view of an upper portion of an outer ring of the bearing;

FIG. 7 is a side plan view of a first separator of the bearing;

FIG. 8 is a broken-away, enlarged portion of FIG. 7;

FIG. 9 is a side plan view of a second separator of the bearing;

FIG. 10 is a broken-away, enlarged view of a portion of FIG. 9;

FIG. 11 is a broken-away, enlarged axial cross-sectional view of an upper portion of the inner ring shown with a first ball set and the first separator installed on the inner ring;

FIG. 12 is a broken-away, enlarged axial cross-sectional view of an upper portion of the inner ring, a central ring portion of the outer ring and a first end ring portion of the outer ring, shown with the first ballset installed between the inner and outer rings;

FIG. 13 is a broken-away, more enlarged view of a portion of FIG. 12, showing the installation of a second ballset; and

FIG. 14 is a broken-away, enlarged view of the upper portion of the bearing, showing the three ring portions of the outer ring connected together to complete assembly of the bearing.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

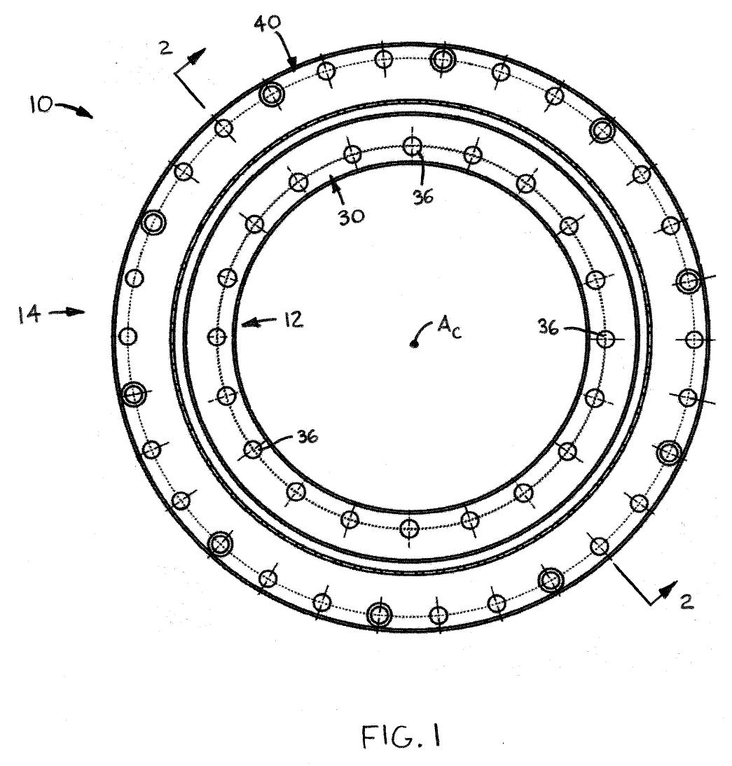

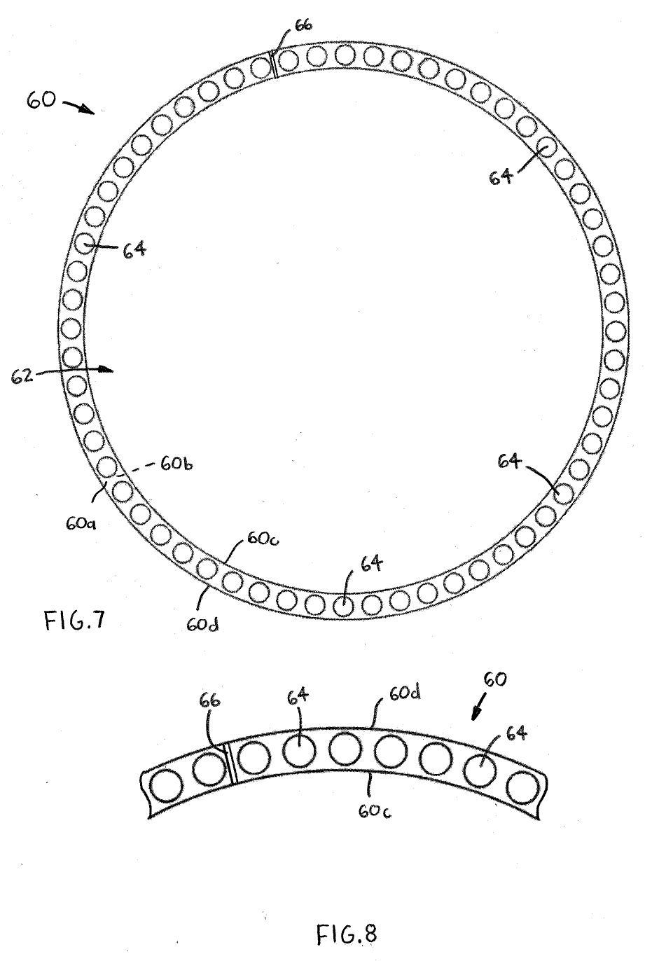

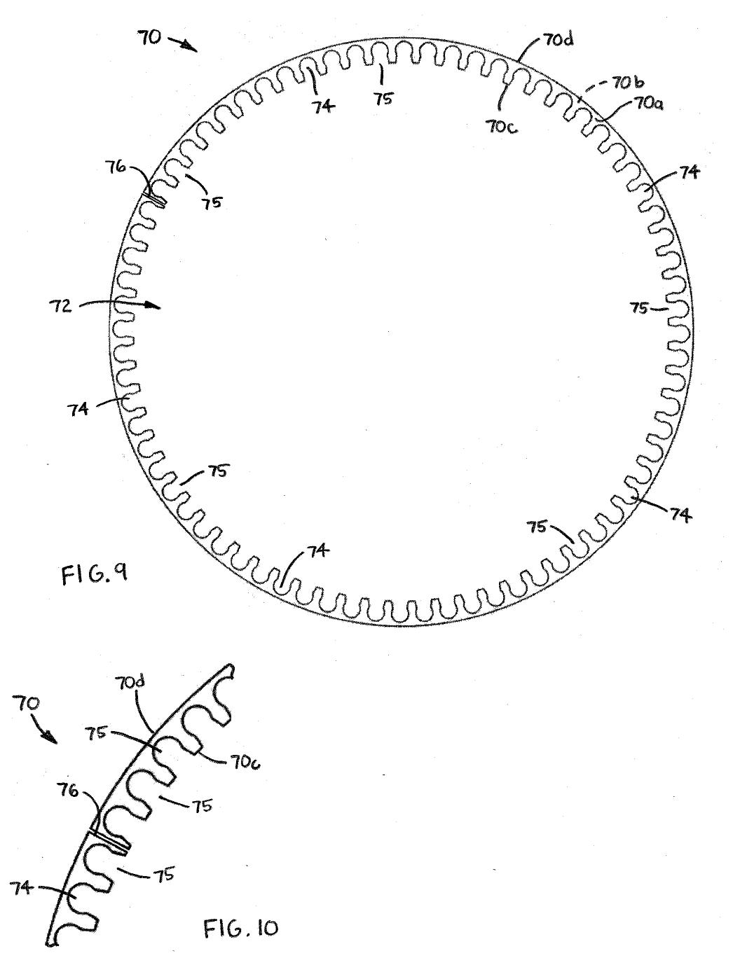

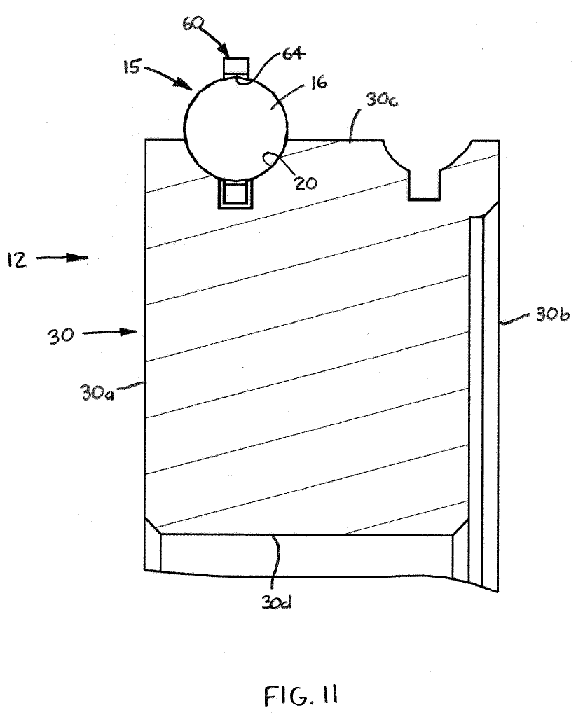

Referring now to the drawings in detail, wherein like numbers are used to indicate like elements throughout, there is shown in FIGS. 1-14 a thin-section bearing 10 for rotatably coupling a rotatable inner member 1 with a fixed outer member 2. The two members 1, 2 are preferably components of a robot (not shown) for use in semiconductor or medical applications, but may be part of any other application in which relatively high stiffness and low torque is desired. The thin-section bearing 10 basically comprises an inner ring 12 connectable with the inner member 1, an outer ring 14 connectable with the outer member 2, a first set 15 of balls 16 and a second set 17 of balls 18, the first and second ball sets 15, 17 being disposed between and rotatably coupling the inner and outer rings 12, 14. The inner ring 12 has first and second inner raceways 20, 22, respectively, and the outer ring 14 has first and second outer raceways 24, 26, respectively, each one of the raceways 20, 22, 24 and 26 being formed to provide two contact points for each ball 16 and 18, such that the bearing 10 is an “eight-point contact” bearing as discussed below.

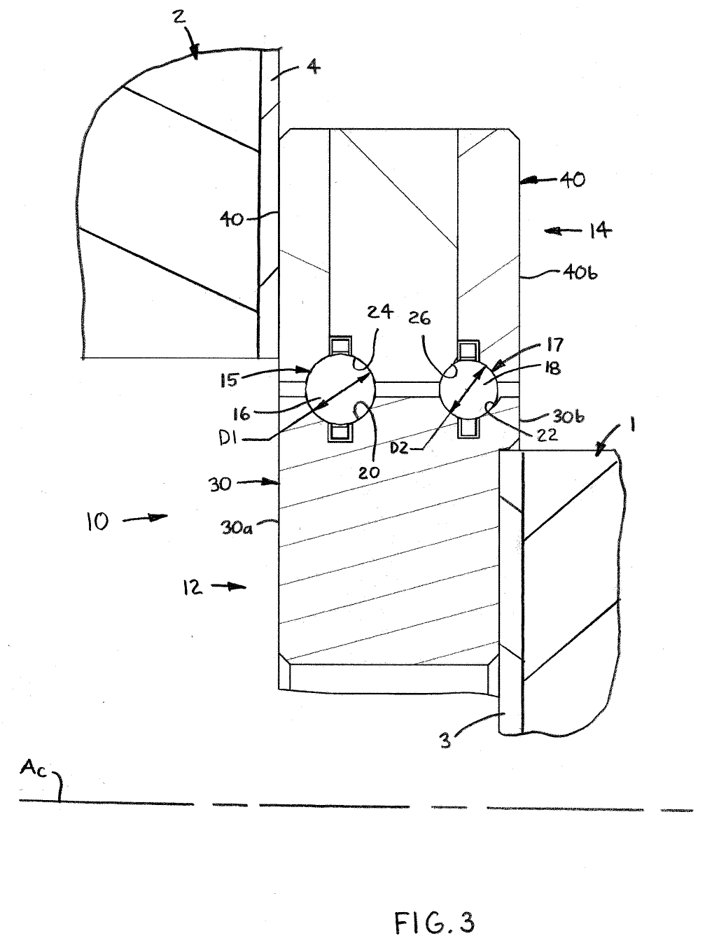

More specifically, the inner ring 12 has a central axis A_{C} and includes a single annular body 30 with two opposing axial ends 30a, 30b, an inner radial end 30d and an outer radial end 30c. As shown in FIG. 3, one of the two axial ends 30a, 30b is disposeable against the inner member 1 or an intermediate member 3 when the inner ring 12 is connected with the inner member 1, as discussed below. The first inner raceway 20 and the second inner raceway 22 are spaced axially apart and each extend radially inwardly from the outer radial end 30c.

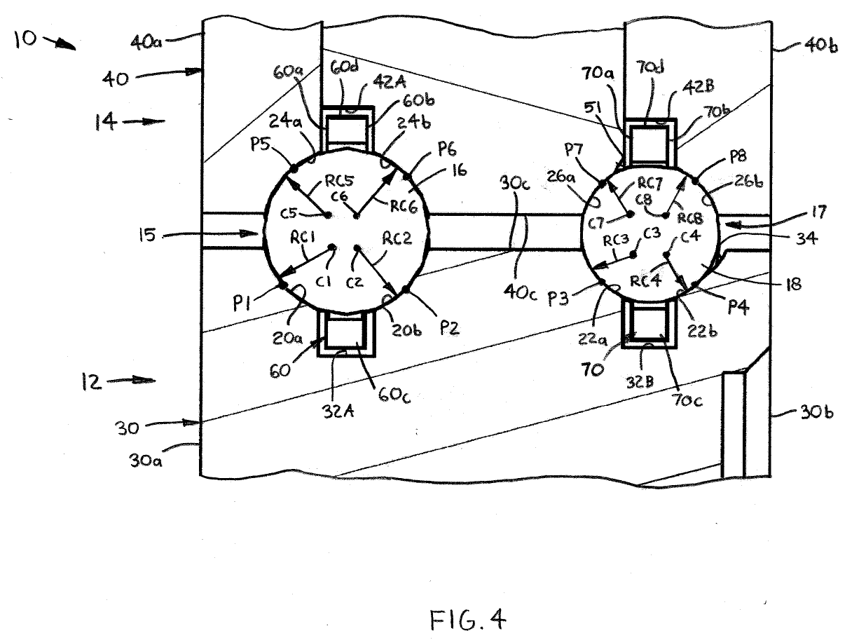

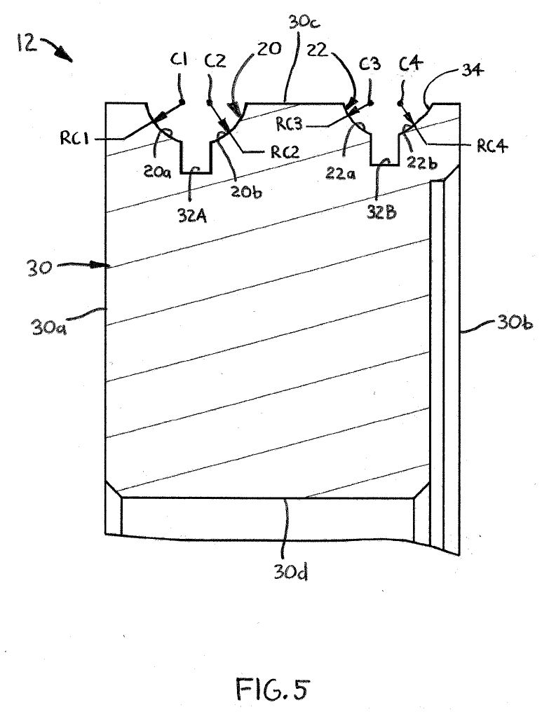

Referring now to FIGS. 4 and 5, each one of the first and second inner raceways 20, 22 has a pair of curved surface sections 20a, 20b, and 22a, 22b, respectively. Each curved surface section 20a, 20b of the first raceway 20 has a radius of curvature RC1, RC2, respectively, with a respective center C1, C2, the two centers C1, C2 being spaced axially apart and each radius RC1, RC2 having the same value. Similarly, each curved surface 22a, 22b of the second raceway 22 has a radius of curvature RC3, RC4, respectively, with a respective center C3, C4, the two centers C3, C4 being spaced axially apart and the two radii RC3, RC4 having the same value.

As a result of the offset centers C1, C2 of the first raceway 20 and the offset centers C3, C4 of the second raceway 22, each ball 16 contacts the first inner raceway 20 at two separate contact points P1, P2 and each ball 18 contacts each second inner raceway 22 at two separate contact points P3, P4, for reasons discussed below. Further, the value of the radii RC1, RC2 of the first inner raceway 20 is greater than the value of the radii RC3, RC4 of the second inner raceway 22 as the balls 16 of the first ballset 15 are preferably larger than the balls 18 of the second ballset 17, as also discussed below.

Furthermore, the inner ring 12 preferably further has first and second circumferential grooves 32A, 32B for receiving the inner ends of first and second separators 60, 70 as described below. The first circumferential groove 32A extends radially inwardly from the first inner raceway 20 between the pair of curved surface sections 20a, 20b of the first inner raceway 20. Similarly, the second circumferential groove 32B extends radially inwardly from the second inner raceway 22 between the pair of curved surface sections 22a, 22b of the second inner raceway 22.

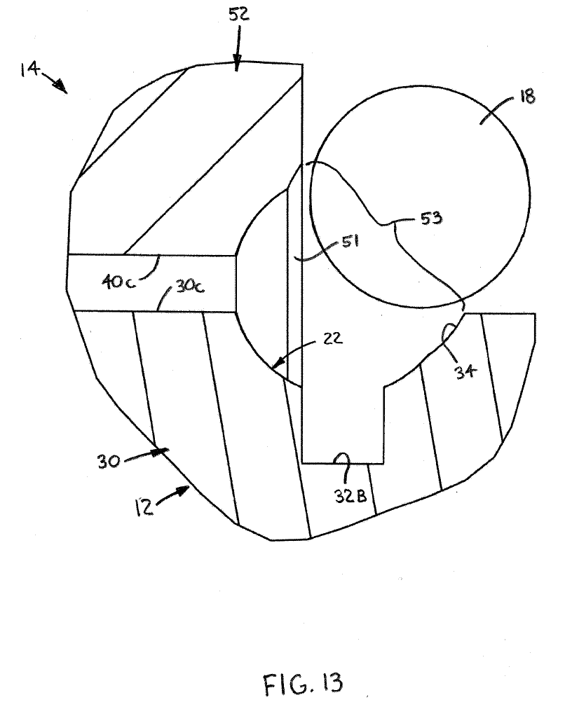

Referring to FIGS. 4, 5 and 13, the inner ring 12 also has an angled circumferential lead-in surface portion 34 extending between the outer radial end 30c of the inner ring body 30 and the second inner raceway 22, specifically to the surface section 22b. The lead-in surface 34 forms an installation gap 45 with a facing lead-in surface 51 of the outer ring 14, as shown in FIG. 13 and described in further detail below. Preferably, the inner ring 12 has at least one and preferably a plurality of circumferentially spaced connective holes 36 each receiving a separate fastener (not shown) for connecting the inner ring 12 to the inner member 1, as shown in FIG. 1.

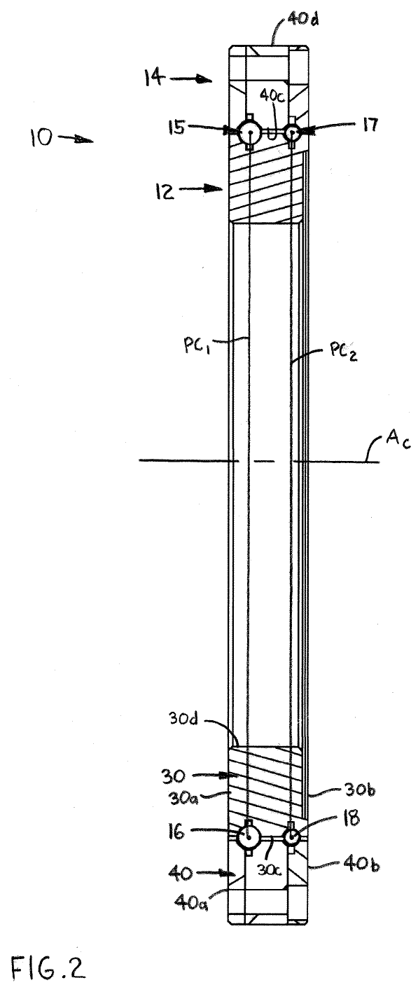

Referring now to FIGS. 2-4 and 6, the outer ring 14 is disposed coaxially about the inner ring 12 and includes an annular body 40, which is preferably multi-piece as described below, with two opposing axial ends 40a, 40b, an inner radial end 40c and an outer radial end 40d. One of the two axial ends 40a, 40b is disposeable against the outer member 2 or another intermediate member 4 when the outer ring 14 is connected with the outer member 2, as discussed below. The first outer raceway 24 and the second outer raceway 26 are spaced axially apart and each extend radially outwardly from the inner radial end 40c.

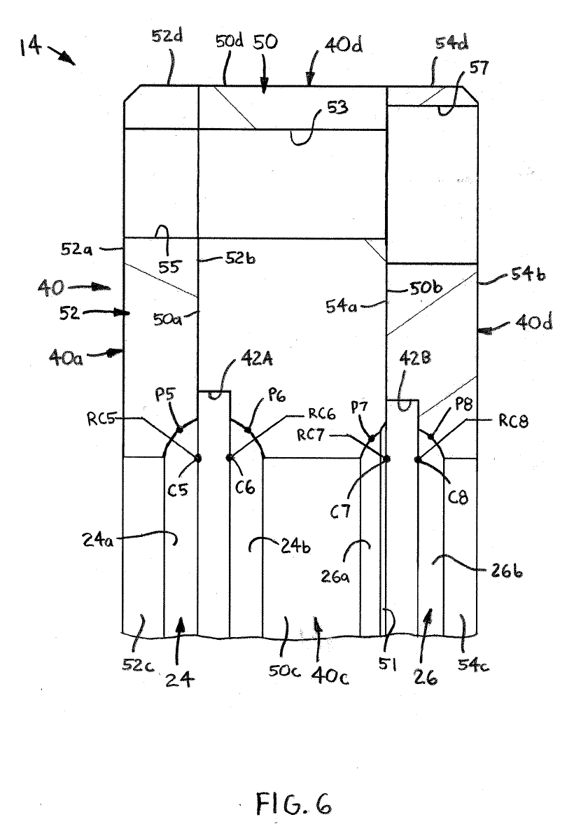

Referring now to FIGS. 4 and 6, each one of the first and second outer raceways 24, 26 has a pair of curved surface sections 24a, 24b, and 26a, 26b, respectively. Each curved surface 24a, 24b of the first outer raceway 24 has a radius of curvature RC5, RC6, respectively, with a respective center C5, C6, the two centers C5, C6 being spaced axially apart and each radius RC5, RC6 having the same value. Similarly, each curved surface 26a, 26b of the second outer raceway 26 has a radius of curvature RC7, RC8, respectively, with a respective center C7, C8, the two centers C7, C8 being spaced axially apart and the two radii RC7, RC8 having the same value.

As a result of the offset centers C5, C6 of the first raceway 24 and the offset centers C7, C8 of the second raceway 26, each ball 16 contacts the first outer raceway 24 at two separate contact points P5, P6 and each ball 18 contacts the second outer raceway 26 at two separate contact points P7, P8, for reasons discussed below. Further, as with the inner raceways 20, 22, the value of the radii RC7, RC6 of the first outer raceway 24 is greater than the value of the radii RC7, RC8 of the second outer raceway 26 as the balls 16 of the first ballset 15 are preferably larger than the balls 18 of the second ballset 17, as also described in further detail below. Also, the value of the radii R5, R6 of the first outer raceway 24 is equal to the value of the radii R1, R2 of the first inner raceway 20 and similarly, the value of the radii R7, R8 of the second outer raceway 26 is equal to the value of the radii R3, R4 of the second inner raceway 22, such that the balls 16 and 18 roll freely along the associated inner and outer raceways 20, 24 and 22, 26, respectively.

Furthermore, the outer ring 14 also first and second circumferential grooves 42A, 42B for receiving the outer radial ends of the first and second separators 60, 70 as mentioned above and described in detail below. The first circumferential groove 42A extends radially outwardly from the first outer raceway 24 between the pair of curved surface sections 24a, 24b of the first outer raceway 24. Similarly, the second circumferential groove 42B extends radially outwardly from the second outer raceway 24 between the pair of curved surface sections 26a, 26b of the second outer raceway 26. Further, the outer ring 14 further has at least one and preferably a plurality of circumferentially spaced connective holes 46 each receiving a separate fastener 47 for connecting the outer ring 14 to the outer member 2.

Referring now to FIGS. 6 and 12-14, as discussed above, the outer ring 14 is preferably formed multi-piece, and most preferably of three pieces, in order to facilitate the assembly of the bearing 10, in particular the installation of the preferred ball sets 15, 17 as described in detail below. Specifically, the outer ring 14 preferably includes a central ring portion 50 and two end ring portions 52, 56 which are all axially stacked and collectively provide the outer ring inner and outer ends 40c, 40d and the first and second outer raceways 24, 26, as follows.

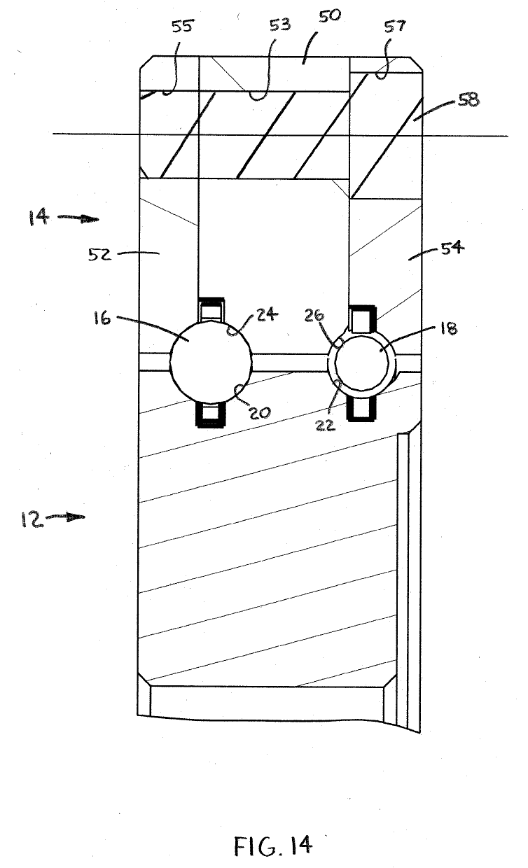

The central ring portion 50 has first and second axial ends 50a, 50b and inner and outer radial ends 50c, 50d. The axially-inner curved surface section 24b of the first outer raceway 24 extends between the first axial end 50a and the inner radial end 50c and the axially-inner curved surface section 26a of the second outer raceway 26 extends between the second axial end 50b and the inner radial end 50c. Further, the first circumferential groove 42A extends radially outwardly from an outer axial end (not indicated) of the curved surface section 24b and axially inwardly from the first axial end 50a of the central ring portion 50. Also, an angled circumferential lead-in surface portion 51 extends between the second axial end 50b of the central ring portion 50 and the axially-inner curved surface section 26a of the second outer raceway 24. The lead-in surface portion 51 faces the lead-in surface portion 36 of the inner ring body 30 and forms an installation gap 53 through which the balls 18 of the second ball set 17 are insertable as described below. Furthermore, at least one and preferably a plurality of connective through holes 53 extend between the first and second axial ends 50a, 50b, each through hole 53 receiving a portion of a fastener 58 (FIG. 14) for connecting the end ring portions 50, 52, 54 as described below.

Still referring to FIGS. 6 and 12-14, the first end ring portion 52 has an inner axial end 52a disposed against the first axial end 50a of the central ring portion 50, an outer axial end 52b providing the outer ring first axial end 40a, an inner radial end 52c and an outer radial end 52d. The axially-outer curved surface section 24a of the first outer raceway 24 extends between the inner axial end 52a and the inner radial end 50c of the first end ring portion 52. Also, at least one and preferably a plurality of connective openings 55 extend at least partially, and preferably entirely, through the first end ring portion 52 and is alignable with the openings 53 of the central ring portion 52.

Further, the second end ring portion 54 has an inner axial end 54a disposed against the second axial end 50b of the central ring portion 50, an outer axial end 54b providing the outer ring second axial end 40b, an inner radial end 54c and an outer radial end 54d. The axially-outer curved surface section 26b of the second outer raceway 26 extends between the inner axial end 54a and the inner radial end 54c of the second end ring portion 54. Also, the second circumferential groove 42B extends radially outwardly from an outer axial end (not indicated) of the curved surface section 26b and axially outwardly from the inner axial end 54a of the second end ring portion 54. Furthermore, the second end ring portion 54 includes at least one and preferably a plurality of connective openings 57 extending at least partially, and preferably entirely, through the end ring portion 52 and are each alignable with the openings 53 of the central ring portion 52.

Referring now to FIGS. 2-4, the first ball set 15 includes a number N1 of the first balls 16 disposed between the first inner raceway 20 and the first outer raceway 24 and spaced circumferentially about the central axis A_{C}. Each first ball 16 has a first ball diameter D1 (FIG. 3) and contacts each one of the curved surface sections 20a, 20b and 24a, 24b of both of the first inner and outer raceways 20, 24, respectively, at the four contact points P1, P2, P5 and P6, respectively. Also, the specific number of balls 16 of the first ball set 15 is selected such that at least sixty-five and two tenths percent (65.2%) of a pitch circle PC1 (FIG. 2) defined between the first inner and outer raceways 20, 24 is occupied by the first ball set 15. As is known in the bearing art, a “pitch circle” is a theoretical circular path traversed by the center of each rolling element as the rolling elements circulate between a pair of raceways.

Further, the second ball set 17 includes a number of second balls 18 disposed between the second inner raceway 22 and the second outer raceway 26. Each second ball 18 has a second ball diameter D2 and contacts each one of the curved surface sections 22a, 22b and 26a, 26b of both of the second inner and outer raceways 22, 26, respectively, at the four contact points P3, P4, P7 and P8, respectively. The second diameter D2 is less than the first diameter D1, i.e., the first balls 16 are larger than the second balls 18. Further, the specific number N2 of balls 18 of the second ball set 17 are selected such that at least sixty-five and five tenths percent (65.5%) of a pitch circle PC2 (FIG. 2) defined between the second inner and outer raceways 22, 26 is occupied by the second ball set 17.

Also, the first inner and outer raceways 20, 24 and the second inner and outer raceways 22, 26 are preferably formed such that the two pitch circles PC1, PC2 have equal diameters (not indicated) and the number of second balls 18 is greater than the number of first balls 16. As a result, the first ball set 15 enables the bearing 10 to support relatively greater loading while the second ball set 17 decreases friction within the bearing 10.

Referring to FIGS. 4 and 7-10, as mentioned above, the bearing 10 preferably includes a first annular separator 60 for maintaining spacing between the first balls 16 of the first ball set 15 and a second separator 70 for maintaining spacing between the second balls 18 of the second ball set 17. Specifically, the first annular separator 60 has two opposing axial ends 60a, 60b, an inner radial end 60c, an outer radial end 60d and a central opening 62 defined by the inner radial end 60c. A plurality of pockets 64 are spaced circumferentially apart and each extends between the axial ends 60a, 60b. Further, a slotted opening 66 extends radially between the inner and outer radial ends 60c, 60d and axially between the two axial ends 60a, 60b, the slotted opening 66 enabling the separator 60 to be bendable or deflectable so as to enlarge the central opening 62 during installation about the inner ring 12.

When the bearing 10 is fully assembled as discussed below, the inner radial end 60c of the first separator 60 is disposed within the first circumferential groove 32A of the inner ring 12 and the outer radial end 60d is disposed within the first circumferential groove 42A of the outer ring 40, as indicated in FIG. 4. As such, the first separator 60 extends radially between and within the inner and outer rings 12, 14, as opposed to a typical separator which extends axially between and is spaced from each of the inner and outer bearing rings.

Similarly, the second annular separator 70 has two opposing axial ends 70a, 70b, an inner radial end 70c, an outer radial end 70d and a central opening 72 defined by the inner radial end 70c, with a plurality of pockets 74 being spaced circumferentially apart and extending between the axial ends 70a, 70b. A slotted opening 76 extends radially between the inner and outer radial ends 70c, 70d and axially between the two axial ends 70a, 70b so as to enable bending/deflection of the separator 70 and enlargement of the central opening 72 during installation. Further, each one of the pockets 74 of the second separator 70 has an installation opening 75 at the separator inner radial end 70c, such that a separate one of the balls 18 of the second ball set 17 is insertable through each one of the installation openings 75 during installation of the second separator 70 as described below.

As with the first separator 60, the second separator 70 is located within the bearing 10 such that the inner radial end 70c of the separator 70 is disposed within the second circumferential groove 32B of the inner ring 12 and the outer radial end 70d is disposed within the second circumferential groove 42B of the outer ring 40, as indicated in FIG. 4. Thus, the second separator 70 also extends radially between and within the inner and outer rings 12, 14.

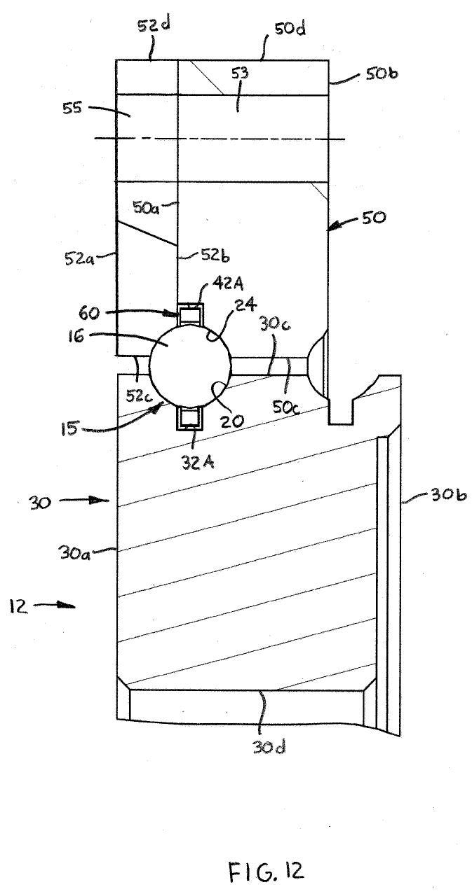

Referring now to FIGS. 11-14, with the preferred components described above, the present thin-section bearing 10 is assembled generally in the following manner. First, the first separator 60 is disposed about the first inner raceway 20 of the inner ring 12, such that the inner radial end 60c of the separator 60 is disposed within the first circumferential groove 32A and the separator 60 extends radially. Specifically, a pulling force is exerted on the separator 60 such that the separator slotted opening 66 allows the central opening 62 to be enlarged to the extent necessary to axially slide the separator 60 onto the first axial end 30a of the inner ring body 30 and over the ring outer radial end 30c until the separator 60 is disposed around the first inner raceway 20. Then, the force is released such that the separator inner radial end 60c enters the circumferential groove 32A. Next, the first ball set 15 is installed about the first inner raceway 20, preferably by inserting each first ball 16 into a separate pocket 64 of the first separator 60, as depicted in FIG. 11.

After installation of the first balls 16, the first end ring portion 52 and the central ring portion 50 of the outer ring 14 are disposed about the inner ring 12, as depicted in FIG. 12, such that the outer radial end 60d of the separator 60 becomes disposed within the first circumferential groove 42A of the outer ring 14. Then, the second ball set 17 is installed about the second inner raceway 21 by inserting each second ball 18 through the installation gap 53 between the central ring portion 50 and the inner ring 21, as shown in FIG. 13. After all of the balls 18 are disposed about the inner ring 12, the second separator 70 is pulled open and pushed onto the inner ring second axial end 30b and axially displaced over the inner ring outer end 30d until disposed against the axial end 50b of the outer ring central portion 50. Each second ball 18 becomes inserted through a separate one of the installation openings 75 and into the pocket 74 connected with the opening 75 until all of the balls 18 are installed within the second separator 70. Next, the second end ring portion 54 is disposed about the inner ring 12 and against the central ring portion 50 such that the outer radial end 70d of the second separator 70 becomes disposed within the second circumferential groove 42B of the outer ring 14.

Finally, the first end ring portion 52, the central ring portion 50 and the second end ring portion 54 are connected by inserting at least one and preferably a plurality of the fasteners 58 through the aligned openings 55, 53 and 57 of the ring portions 52, 50, 54, respectively. The thin-section bearing 10 of the present invention is then fully assembled and ready for use in any appropriate application. To install the bearing 10 into a desired application, such as in a joint of a medical device or an item of semiconductor manufacturing equipment, one of the axial ends 30a or 30b of the inner ring 12 is disposed against an inner member 1 or an intermediate member 3 (e.g., spacer, a washer, etc.) and the inner ring 12 is connected with the inner member 1 and/or the intermediate member 3, preferably by means of a plurality of fasteners (none shown), as shown in FIG. 3. Similarly, an axial end 14a or 14b of the outer ring 14 is disposed against an outer inner member 2 or another intermediate member 4 and connected therewith by a plurality of fasteners (not shown), as depicted in FIG. 3. The bearing 10 is then capable of transmitting motion and torque between the inner and outer members 1, 2.

The present thin-section bearing 10 has a number of benefits over previous known designs for similar applications. By providing the two sets 15, 17 of balls 16, 18 which each make four-point contact with the inner and outer raceways 20, 24 and 22, 26, such that the bearing 10 is an “eight-point” contact bearing, the bearing 10 is capable of supporting substantial radial loading and axial loading in both directions along the central axis Ac. Such bi-directional axial load capacity is at least equivalent to providing two angular contact bearings, but in a more axially compact profile. By providing the number N1, N2 of each ball set 15, 17 so as to be almost “full complement”, both the load capacity and the stiffness of the bearing 10 is significantly increased in comparison with a typical “Conrad” arrangement. Further, by providing a combination of two different diameter balls 16, 18, the bearing 10 has a balance of increased load capacity, increased stiffness, reduced friction and ease of assembly.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A thin-section bearing for rotatably coupling a rotatable inner member with a fixed outer member, the bearing comprising:
an inner ring connectable with the inner member and having a central axis, a first inner raceway and a second inner raceway spaced axially from the first inner raceway, each one of the first and second inner raceways having a pair of curved surface sections each having a radius of curvature with a center, the centers of the two radii of curvature of each pair of curved surface sections being spaced axially apart;
an outer ring disposed coaxially about the inner ring, connectable with the outer member and having a first outer raceway disposed about the first inner raceway and a second outer raceway spaced axially from the first inner raceway and disposed about the second inner raceway, each one of the first and second outer raceways having a pair of curved surface sections each having a radius of curvature with a center, the centers of the two radii of curvature of each pair of curved surface sections of the first and second outer raceways being spaced axially apart;
a first ball set including a plurality of first balls disposed between the first inner raceway and the first outer raceway, each first ball having a first diameter and contacting each one of the curved surface sections of both of the first inner and outer raceways, the number of balls of the first ball set being selected such that at least sixty-five and two tenths percent (65.2%) of a pitch circle defined between the first inner and outer raceways is occupied by the first ball set; and
a second ball set including a plurality of second balls disposed between the second inner raceway and the second outer raceway, each second ball having a second diameter and contacting each one of the curved surface sections of both of the second inner and outer raceways, the second diameter being less than the first diameter and the number of balls of the second ball set being selected such that at least sixty-five and five tenths percent (65.5%) of a pitch circle defined between the second inner and outer raceways is occupied by the second ball set.

2. The bearing as recited in claim 1, wherein:
the inner ring has a first circumferential groove extending radially inwardly from the first inner raceway between the pair of curved surface sections of the first inner raceway and a second circumferential groove extending radially inwardly from the second inner raceway and between the pair of curved surface sections of the second inner raceway;
the outer ring has a first circumferential groove extending radially outwardly from the first outer raceway between the pair of curved surface sections of the first outer raceway and a second circumferential groove extending radially outwardly from the second outer raceway between the pair of curved surface sections of the first inner raceway; and
the bearing further comprises:
a first annular separator having two opposing axial ends, a plurality of pockets spaced circumferentially apart and each extending between the axial ends, an inner radial end disposed within the first circumferential groove of the inner ring and an outer radial end disposed within the first circumferential groove of the outer ring, each ball of the first set of balls being disposed within a separate one of the pockets of the first separator; and
a second separator having a plurality of pockets, an inner radial end disposed within the second circumferential groove of the inner ring and an outer radial end disposed within the second circumferential groove of the outer ring, each ball of the second set of balls being disposed within a separate one of the pockets of the second separator.

3. The bearing as recited in claim 2, wherein each one of the first and second separators has a central opening and a slotted opening extending radially between the inner and outer radial ends and axially between the two axial ends, the slotted opening of each one of the first and second separators enabling each separator to be bendable so as to enlarge the central opening during installation of each one of the first and second separators about the inner ring.

4. The bearing as recited in claim 2, wherein each one of the pockets of the second separator has an installation opening at the inner radial end of the second separator such that a separate one of the balls of the second ball set is insertable through each one of the installation openings of the plurality of pockets when the second separator is assembled about the inner ring.

5. The bearing as recited in claim 1, wherein:
the inner ring has two axial ends, an inner radial end and an outer radial end, one of the two axial ends being disposeable against the inner member or an intermediate member when the inner ring is connected with the inner member, the first and second inner raceways extending radially inwardly from the outer radial end; and
the outer ring has two axial ends, an inner radial end and an outer radial end, one of the two axial ends of the outer ring being disposeable against the outer member or another intermediate member when the outer ring is connected with the inner member, the first and second outer raceways extending radially outwardly from the inner radial end of the outer ring.

6. The bearing as recited in claim 1, wherein the outer ring includes:
a central ring portion having first and second axial ends and inner and outer radial ends, one of the first outer raceway curved surface sections extending between the first axial end and the inner radial end and one of the second outer raceway curved surface sections extending between the second axial end and the inner radial end;
a first end ring portion having an inner axial end disposed against the first axial end of the central ring portion, an outer axial end, an inner radial end and an outer radial end, the other one of the two curved surface sections of the first outer raceway extending between the inner axial end and the inner radial end of the first end ring portion; and
a second end ring portion having an inner axial end disposed against the second axial end of the central ring portion, an outer axial end, an inner radial end and an outer radial end, the other one of the two curved surface sections of the second outer raceway extending between the inner axial end and the inner radial end of the second end ring portion.

7. The bearing as recited in claim 6, wherein:
the central ring portion has a circumferential groove extending radially outwardly from an outer axial end of the one first outer raceway curved surface section and axially from the first axial end of the central ring portion;
the second end ring portion has a circumferential groove extending radially outwardly from an outer axial end of the other one second outer raceway curved surface sections and axially from the inner axial end of the second end ring portion; and
the bearing further comprises a first annular separator having a plurality of pockets spaced circumferentially apart and an outer radial end disposed within the circumferential groove of the central ring portion, each ball of the first set of balls being disposed within a separate one of the pockets of the first separator, and a second separator having a plurality of pockets spaced circumferentially apart and an outer radial end disposed within the circumferential groove of the second end ring portion, each ball of the second set of balls being disposed within a separate one of the pockets of the second separator.

8. The bearing as recited in claim 7, wherein the inner ring has:
a first circumferential groove extending radially inwardly from the first inner raceway and located axially between the two curved surface sections of the first inner raceway, a radial inner end of the first annular separator being disposed in the first circumferential groove of the inner ring; and
a second circumferential groove extending radially inwardly from the second inner raceway and located axially between the two curved surface sections of the second inner raceway, a radial inner end of the second annular separator being disposed in the second circumferential groove of the inner ring.

9. The bearing as recited in claim 6, wherein:
the central ring portion has an angled circumferential lead-in surface portion extending between the second axial end of the central ring portion and the one of the second outer raceway curved surface sections; and
the inner ring has an angled circumferential lead-in surface section portion extending between the outer radial end of the inner ring and the second inner raceway and facing the lead-in surface on the central ring portion such that an installation gap is defined between the two lead-in surface sections, each ball of the second ball set being insertable through the installation gap so as to be disposed between the inner ring and the outer ring.

10. The bearing as recited in claim 1, wherein the number of balls of the second ball set is greater than the number of balls of the first ball set.

11. A thin-section bearing for rotatably coupling a rotatable inner member with a fixed outer member, the bearing comprising:
an inner ring connectable with the inner member and having a central axis, a first inner raceway and a second inner raceway spaced axially from the first inner raceway, each one of the first and second inner raceways having a pair of curved surface sections each having a radius of curvature with a center, the centers of the two radii of curvature of each pair of curved surface sections being spaced axially apart;
an outer ring disposed coaxially about the inner ring, connectable with the outer member and including:
a central ring portion having first and second axial ends and inner and outer radial ends, a first curved surface section of a first outer raceway extending between the first axial end and the inner radial end and a second curved surface section of a second outer raceway extending between the second axial end and the inner radial end;
a first end ring portion having an inner axial end disposed against the first axial end of the central ring portion, an outer axial end, an inner radial end, an outer radial end, and a curved surface section of the first outer raceway extending between the inner axial end and the inner radial end of the first end ring portion and forming the first outer raceway with the first curved surface section of the central ring portion;
and
a second end ring portion having an inner axial end disposed against the second axial end of the central ring portion, an outer axial end, an inner radial end, an outer radial end, and a curved surface section of the second outer raceway extending between the inner axial end and the inner radial end of the second end ring portion and forming the second outer raceway with the second curved surface section of the central ring portion;
a first ball set including a plurality of first balls disposed between the first inner raceway and the first outer raceway; and
a second ball set including a plurality of second balls disposed between the second inner raceway and the second outer raceway.

12. The bearing as recited in claim 11, wherein:
the inner ring has a first circumferential groove extending radially inwardly from the first inner raceway between the pair of curved surface sections of the first inner raceway and a second circumferential groove extending radially inwardly from the second inner raceway and between the pair of curved surface sections of the second inner raceway;
the outer ring has a first circumferential groove extending radially outwardly from the first outer raceway between the pair of curved surface sections of the first outer raceway and a second circumferential groove extending radially outwardly from the second outer raceway between the pair of curved surface sections of the first inner raceway; and
the bearing further comprises:
a first annular separator having two opposing axial ends, a plurality of pockets spaced circumferentially apart and each extending between the axial ends, an inner radial end disposed within the first circumferential groove of the inner ring and an outer radial end disposed within the first circumferential groove of the outer ring, each ball of the first set of balls being disposed within a separate one of the pockets of the first separator; and
a second separator having a plurality of pockets, an inner radial end disposed within the second circumferential groove of the inner ring and an outer radial end disposed within the second circumferential groove of the outer ring, each ball of the second set of balls being disposed within a separate one of the pockets of the second separator.

13. The bearing as recited in claim 12, wherein each one of the first and second separators has a central opening and a slotted opening extending radially between the inner and outer radial ends and axially between the two axial ends, the slotted opening of each one of the first and second separators enabling each separator to be bendable so as to enlarge the central opening during installation of each one of the first and second separators about the inner ring.

14. The bearing as recited in claim 11, wherein:
the central ring portion has an angled circumferential lead-in surface portion extending between the second axial end of the central ring portion and the one of the second outer raceway curved surface sections; and
the inner ring has an angled circumferential lead-in surface section portion extending between the outer radial end of the inner ring and the second inner raceway and facing the lead-in surface on the central ring portion such that an installation gap is defined between the two lead-in surface sections, each ball of the second ball set being insertable through the installation gap so as to be disposed between the inner ring and the outer ring.

15. The bearing as recited in claim 11, wherein:
the inner ring has two axial ends, an inner radial end and an outer radial end, one of the two axial ends being disposeable against the inner member or an intermediate member when the inner ring is connected with the inner member, the first and second inner raceways extending radially inwardly from the outer radial end; and
the outer ring has two axial ends, an inner radial end and an outer radial end, one of the two axial ends of the outer ring being disposeable against the outer member or another intermediate member when the outer ring is connected with the inner member, the first and second outer raceways extending radially outwardly from the inner radial end of the outer ring.

16. The bearing as recited in claim 11, wherein each first ball has a first diameter and each second ball has a second diameter, the second diameter being less than the first diameter and a number of balls of the second ball set is greater than a number of balls of the first ball set.

17. A method of assembling a bearing for rotatably coupling a rotatable inner member with a fixed outer member, the method comprising the steps of:
providing a single inner ring having first and second inner raceways spaced axially apart;
providing an outer ring including a central ring portion having a section of a first outer raceway and a section of a second outer raceway, a first end ring portion with another section of a first outer raceway and a second end ring portion with another section of a second outer raceway;
providing a first ball set including a plurality of first balls and a second ball set including a plurality of second balls;
installing the first ball set about the first inner raceway;
disposing the first end ring portion and the central ring portion about the inner ring;
installing the second ball set about the second inner raceway by inserting each ball through a gap between the central ring portion and the inner ring; and
disposing the second end ring portion about the inner ring and against the central ring portion.

18. The method as recited in claim 17, wherein the method further comprises the steps of:
providing a first annular separator with a plurality of circumferentially spaced pockets;
providing a second annular separator with an inner end, a plurality of circumferentially spaced pockets and a plurality of installation openings, each installation opening extending between an the inner end and a separate one of the pockets; each
disposing the first annular separator about the first inner raceway of the inner ring before the step of installing the first ball set within the first inner raceway; and
disposing the second annular separator about the second inner raceway after the step of installing the second ball set within the second inner raceway and including inserting each ball of the second ball set through a separate one of the installation openings and into the pocket connected with the one of the installation openings.

19. The method as recited in claim 17, further comprising the step of connecting the first end ring portion, the central ring portion and the second end ring portion by inserting at least one fastener through at least a portion of each of the first end ring portion, the central ring portion and the second end ring portion.

20. The method as recited in claim 17 further comprising the steps of:
disposing an axial end of the inner ring against the inner member or an intermediate member and connecting the inner ring with at least one of the inner member or the intermediate member; and
disposing an axial end of the outer ring against the inner member or another intermediate member and connecting the outer ring with at least one of the outer member or the other intermediate member.
